(19) United States
(12) Patent Application Publication
(10) Pub. No.: US 2011/0192301 A1
(43) Pub. Date: Aug. 11, 2011

(54) SCREEN PRINTER AND METHOD FOR CLEANING SCREEN PRINTER

(75) Inventors: Seiko Abe, Yamanashi (JP); Tetsuya Tanaka, Yamanashi (JP)

(73) Assignee: PANASONIC CORPORATION, Osaka (JP)

(21) Appl. No.: 13/123,240

(22) PCT Filed: Feb. 22, 2010
(86) PCT No.: PCT/JP2010/001162

§ 371 Date: Apr. 8, 2011

(30) Foreign Application Priority Data
Mar. 16, 2009 (JP) P2009-062316

(51) Int. Cl. B41F 35/00

(52) U.S. Cl. 101/423

(57) ABSTRACT

It is an objective to provide a screen printer capable of properly cleaning a three dimensional mask member intended for a cavity substrate and a method for cleaning the screen printer. A mask member 33 includes, as separate areas, a cavity portion correspondence mask area MRC in which a mask pattern MPC corresponding to cavity portion electrode patterns 11dp are formed on bottom surfaces of fitting portions 33a to be fitted into cavity portions CV and a flat portion correspondence mask area MRF in which a mask pattern MPF corresponding to flat portion electrode patterns 12dp is formed. A cleaning unit 37 comes into contact with lower surfaces of the fitting portions 33a within the cavity portion correspondence mask area MRC, to thus clean the cavity portion correspondence mask area MRC and also comes into contact with a lower surface of the flat portion correspondence mask area MRF, to thus clean the flat portion correspondence mask area MRF.

### TECHNICAL FIELD

The present invention relates to a screen printer that subjects to screen printing a so-called cavity substrate having electrode patterns formed over an upper surface of the substrate and other electrode patterns formed on bottom surfaces of respective apertures made in portions of the upper surface of the substrate, as well as to a method for cleaning the screen printer.

### BACKGROUND ART

A known so-called cavity substrate having electrode patterns formed over an upper surface of the substrate and other electrode patterns on bottom surfaces of respective apertures (cavities) formed in portions of the upper surface of the substrate has hitherto been used as a light-weight high-density substrate in various devices (Patent Document 1).

A three dimensional mask member including a flat portion that contacts an upper surface of a substrate and fitting portions that are formed so as to project from the flat portion and are fitted into cavities is used in a screen printer that applies paste, such as solder paste, to the electrode patterns of such a cavity substrate through screen printing. The mask member has mask patterns that are formed on the respective flat portions and that correspond to electrode patterns laid over the upper surface of the substrate (flat portion electrode patterns) and other mask patterns that are formed on bottom surfaces of the fitting portions and that correspond to electrode patterns (cavity portion electrode patterns) laid on the bottom surfaces of the respective cavities. It is therefore possible to subject the substrate and the mask member to screen printing while holding them in contact with each other, whereby paste can concurrently be printed on (transferred to) both the flat portion electrode patterns and the cavity portion electrode patterns.

### RELATED ART DOCUMENT

### Patent Document

Patent Document 1: JP-A-2008-235761

### DISCLOSURE OF THE INVENTION

### Problem that the Invention is to Solve

However, when there is performed cleaning operation for bringing a cleaning unit into contact with the mask member from below, to thus remove paste residues adhering to a lower surface of the mask member, lower surfaces of the fitting portions corresponding to the cavity portion electrode patterns can be properly cleaned. However, there is encountered a problem of the fitting portions obstructing cleaning of a lower surface of the flat portion corresponding to the flat portion electrode pattern, so that the flat portion cannot be cleaned properly.

Accordingly, the present invention aims at providing a screen printer capable of properly cleaning a three dimensional mask member intended for a cavity substrate, as well as providing a method for cleaning the screen printer.

### Means for Solving the Problem

A screen printer of a first mode of the present invention corresponds to a screen printer that subjects first electrode patterns formed on an upper surface of a substrate and second electrode patterns formed on bottom surfaces of apertures provided on portions of the upper surface of the substrate to screen printing, the printer comprising: a mask member having, respectively as different areas, a second electrode pattern correspondence mask area in which a second electrode pattern correspondence mask pattern corresponding to the second electrode patterns is formed on bottom surfaces of fitting portion to be fitted to the apertures of the substrate and a first electrode pattern correspondence mask area in which a first electrode pattern correspondence mask pattern corresponding to the first electrode patterns is formed; and a cleaning unit that contacts lower surfaces of the respective fitting portions in the second electrode pattern correspondence mask area of the mask member, to thus clean the second electrode pattern correspondence mask area and that contacts a lower surface of the first electrode pattern correspondence mask area of the mask member, to thus clean the first electrode pattern correspondence mask area.

A screen printer of a second mode of the present invention corresponds to the screen printer of the first mode, wherein the first electrode pattern correspondence mask area is made up of one of two areas of the mask member that are situated side by side with a center line of the mask member parallel to a direction of conveyance of the substrate interposed therebetween; and the second electrode pattern correspondence mask area is made up of a remaining one of the two areas of the mask member that are situated side by side with a center line of the mask member parallel to a direction of conveyance of the substrate interposed therebetween.

A method for cleaning a screen printer of a third mode of the present invention corresponds to a method for cleaning a screen printer that subjects to screen printing first electrode patterns formed on an upper surface of a substrate and second electrode patterns formed on bottom surfaces of apertures provided on portions of the upper surface of the substrate, by use of a mask member having, respectively as different areas, a second electrode pattern correspondence mask area in which a second electrode pattern correspondence mask pattern corresponding to the second electrode patterns is formed on bottom surfaces of fitting portions to be fitted to the apertures of the substrate and a first electrode pattern correspondence mask area in which a first electrode pattern correspondence mask pattern corresponding to the first electrode patterns is formed, the cleaning method comprising: a step of brining the cleaning unit into contact with lower surfaces of the respective fitting portions in the second electrode pattern correspondence mask area of the mask member, to thus clean the second electrode pattern correspondence mask area; and a step of bringing the cleaning unit into contact with the lower surface of the first electrode pattern correspondence mask area of the mask member, to thus clean the first electrode pattern correspondence mask area.

A method for cleaning a screen printer of a fourth mode of the present invention corresponds to the method for cleaning a screen printer of the third mode, wherein the first electrode pattern correspondence mask area is made up of one of two areas of the mask member that are situated side by side with a center line of the mask member parallel to a direction of conveyance of the substrate with interposed therebetween; and the second electrode pattern correspondence mask area is made up of a remaining one of the two areas of the mask member that are situated side by side with the center line of the mask member parallel to a direction of conveyance of the substrate interposed therebetween.

### Advantage of the Invention

In the present invention, a mask member has, respectively as different areas, a second electrode pattern correspondence mask area in which a second electrode pattern correspondence mask pattern corresponding to second electrode patterns is formed on bottom surfaces of fitting portions to be fitted to apertures (cavity portions) of a substrate and a first electrode pattern correspondence mask area in which a first electrode pattern correspondence mask pattern corresponding to a first electrode patterns is formed. Cleaning the first electrode pattern correspondence mask area of the mask member and cleaning the second electrode pattern correspondence mask area are performed separately from each other. Therefore, it is possible to clean the first electrode pattern correspondence mask area without being interrupted by the fitting portions in the second electrode pattern correspondence mask area, so that the three dimensional mask member intended for a cavity substrate can properly be cleaned.

### BRIEF DESCRIPTION OF THE DRAWINGS

FIG. 1 is a partial plan view of a screen printer of an embodiment of the present invention.

FIG. 2(a) is a plan view of a cavity substrate that is an objective of printing performed by the screen printer of the embodiment of the present invention, and (b) is a side cross sectional view of the same.

FIG. 3 is a front view of a print execution block provided in the screen printer of the embodiment of the present invention.

FIG. 4(a) is a plan view of a mask member provided in the screen printer of the embodiment of the present invention, and (b) is a side cross sectional view of the same.

FIG. 5 is a block diagram showing a control system of the screen printer of the embodiment of the present invention.

FIGS. 6(a), (b), (c), and (d) are side views of a mask member and the cavity substrate provided in the screen printer of the embodiment of the present invention.

FIGS. 7(a), (b), (c), and (d) are side views of the mask member and the cavity substrate provided in the screen printer of the embodiment of the present invention.

FIG. 8 is a flowchart showing screen printing operation performed by the screen printer of the embodiment of the present invention.

FIGS. 9(a) and (b) are views for describing operation of the screen printer of the embodiment of the present invention.

FIGS. 10(a) and (b) are views for describing operation of the screen printer of the embodiment of the present invention.

FIGS. 11(a) and (b) are views for describing operation of the screen printer of the embodiment of the present invention.

FIGS. 12(a) and (b) are views for describing operation of the screen printer of the embodiment of the present invention.

FIGS. 13(a) and (b) are views for describing operation of a cleaning unit belonging to the screen printer of the embodiment of the present invention.

### MODE FOR IMPLEMENTING THE INVENTION

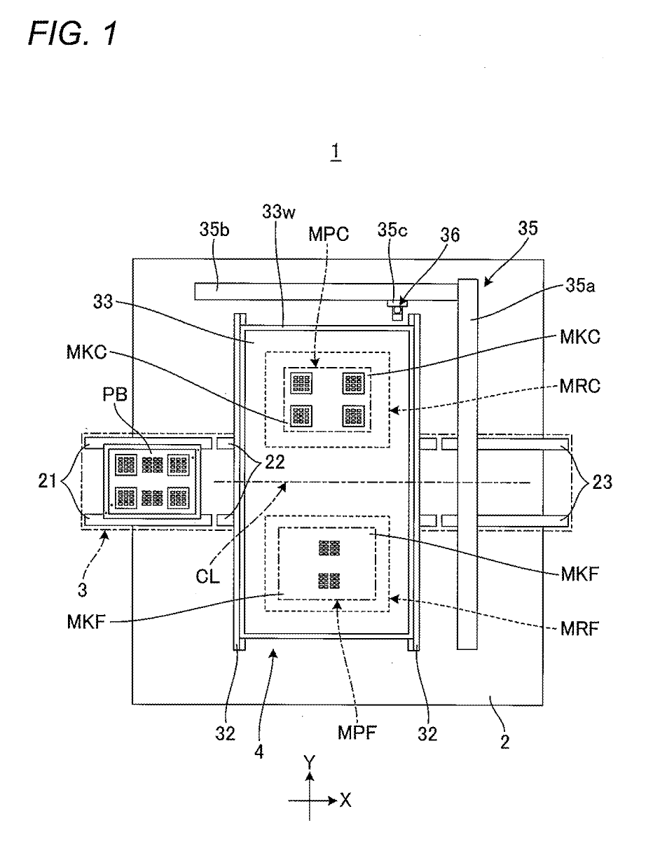

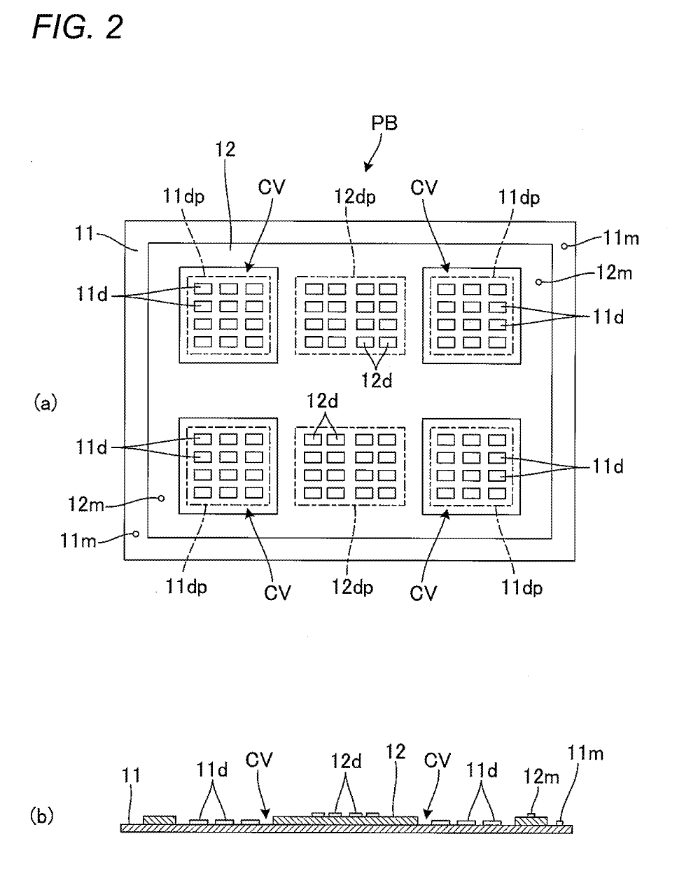

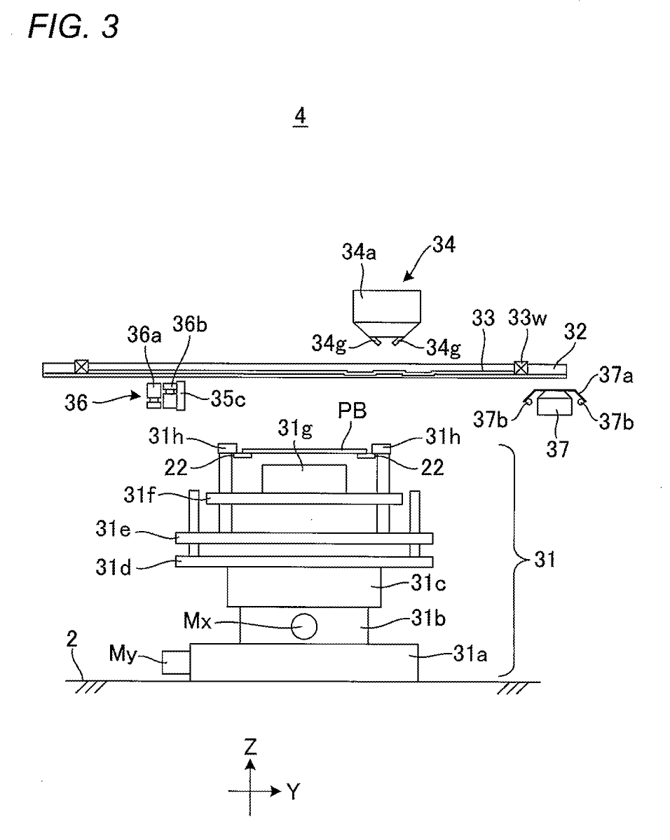

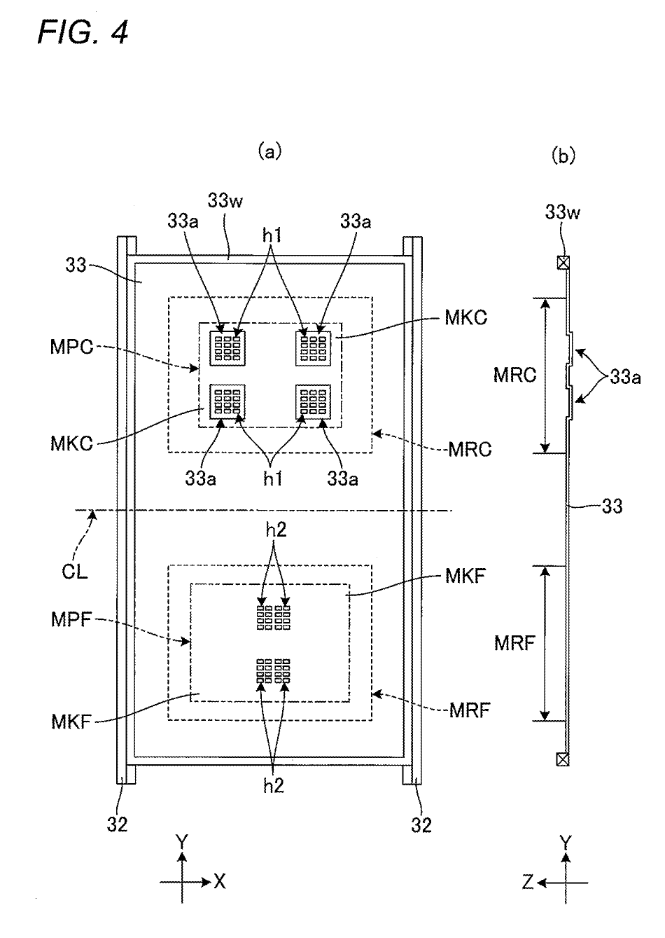

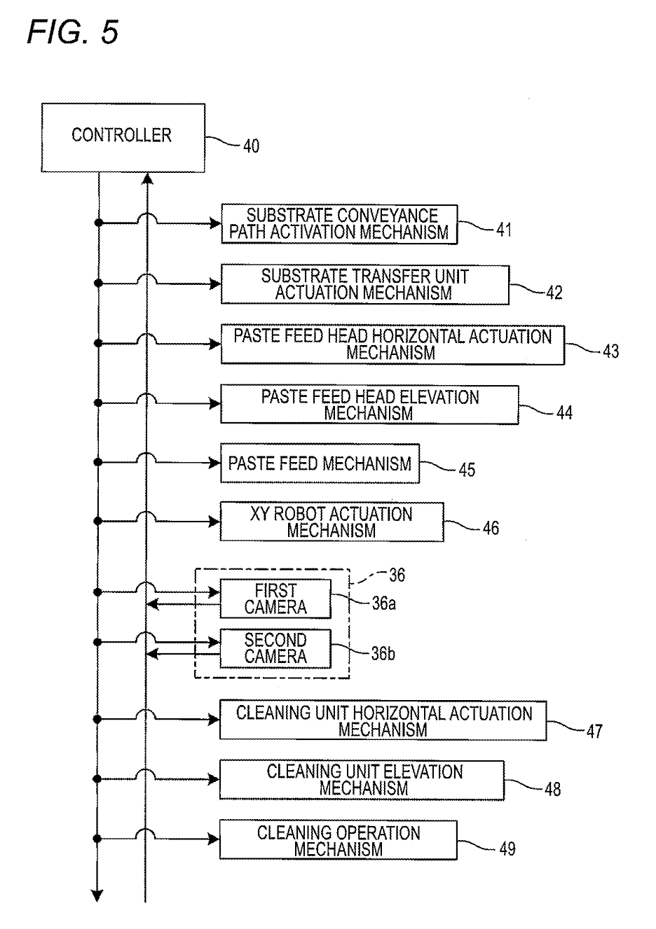

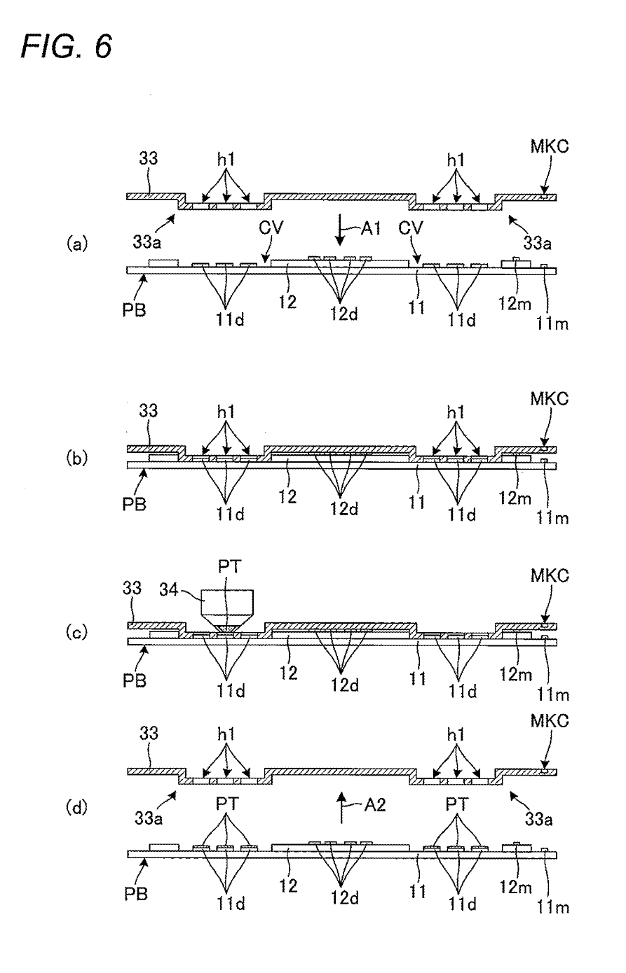

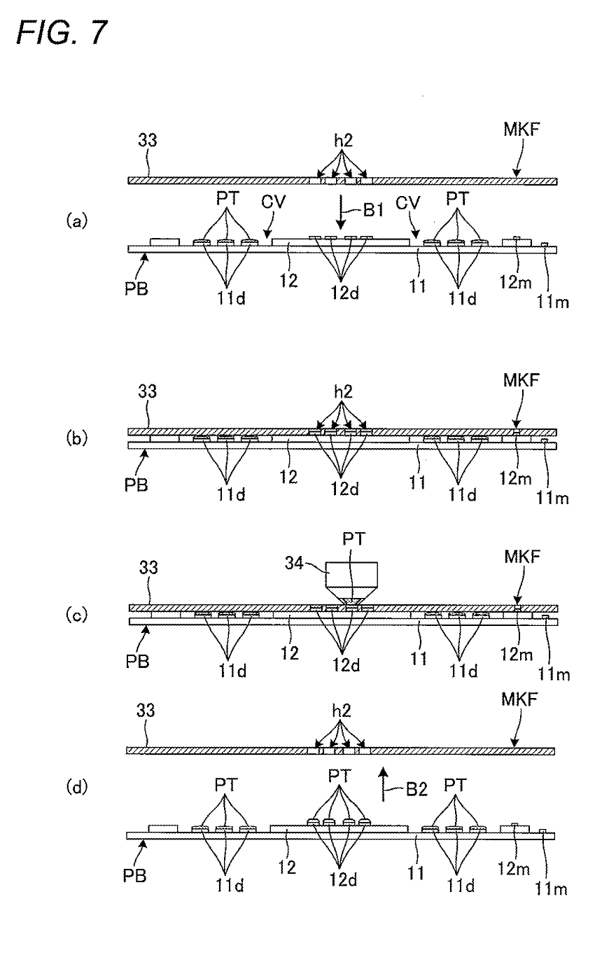

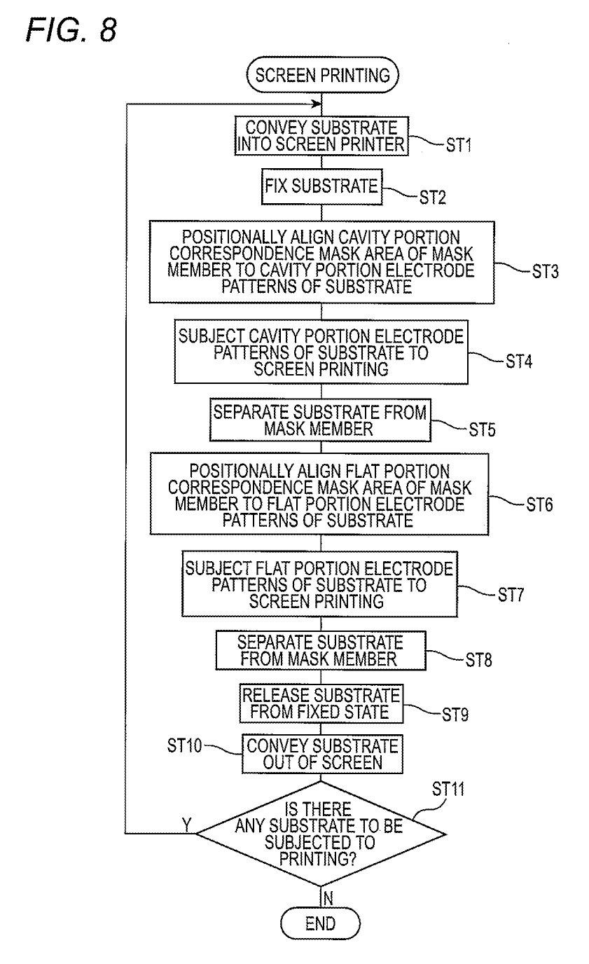

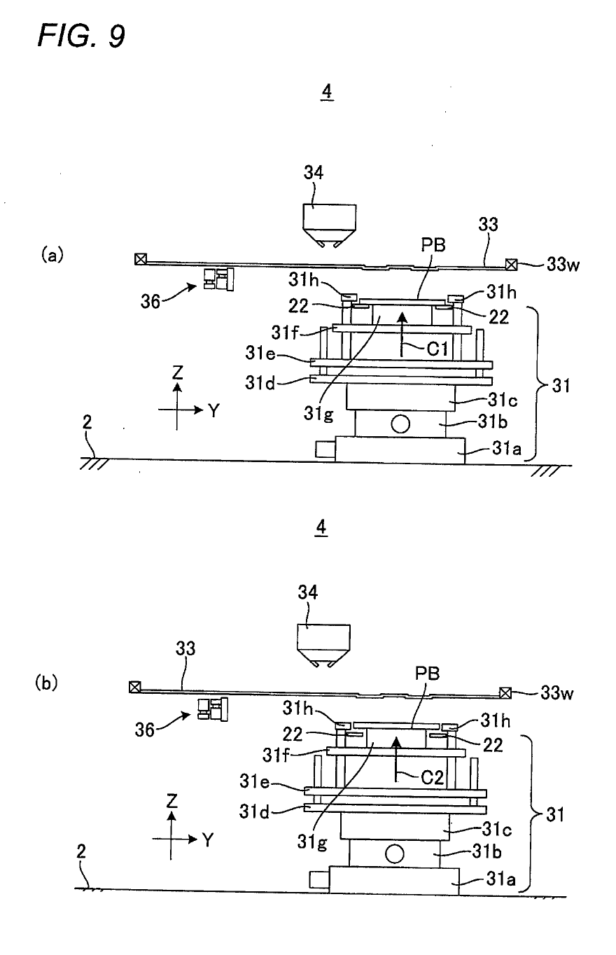

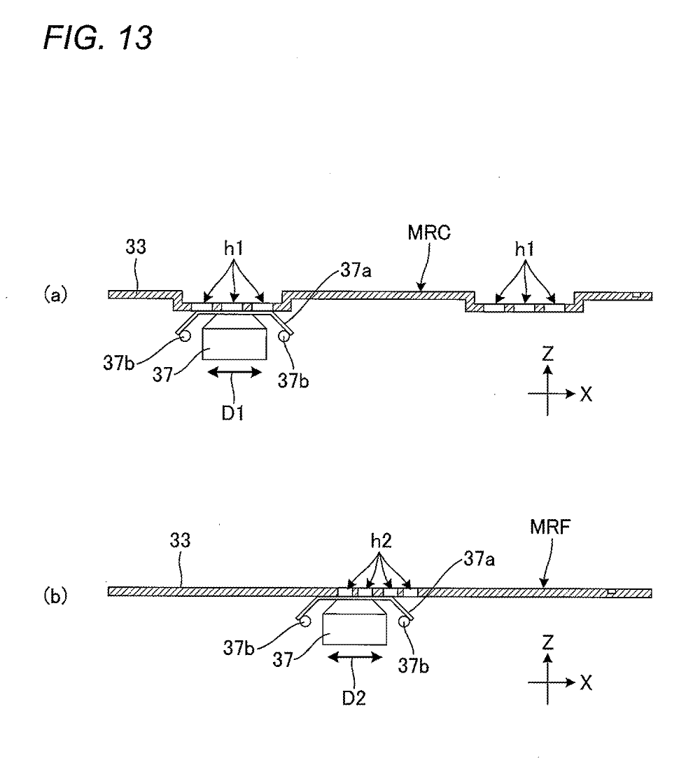

A mode for implementing the present invention is hereunder described by reference to the drawings. FIG. 1 is a partial plan view of a screen printer of an embodiment of the present invention; FIG. 2(a) is a plan view of a cavity substrate that is an objective of printing performed by the screen printer of the embodiment of the present invention and FIG. 2(b) is a side cross sectional view of the same; FIG. 3 is a front view of a print execution block provided in the screen printer of the embodiment of the present invention; FIG. 4(a) is a plan view of a mask member provided in the screen printer of the embodiment of the present invention and FIG. 4(b) is a side cross sectional view of the same; FIG. 5 is a block diagram showing a control system of the screen printer of the embodiment of the present invention; FIGS. 6(a), 6(b), 6(c), 6(d) and 7(a), 7(b), 7(c), 7(d) are side views of a mask member and the cavity substrate provided in the screen printer of the embodiment of the present invention; FIG. 8 is a flowchart showing screen printing operation performed by the screen printer of the embodiment of the present invention; FIGS. 9(a), 9(b), 10(a), 10(b), 11(a), 11(b), 12(a), and 12(b) are views for describing operation of the screen printer of the embodiment of the present invention; and FIGS. 13(a) and 13(b) are views for describing operation of a cleaning unit belonging to the screen printer of the embodiment of the present invention.

In FIG. 1, a screen printer 1 of the present embodiment is built from a base 2; a substrate conveyance path 3 that is laid on the base 2 and that conveys and positions a substrate PB that is an objective of printing; and a print execution block 4 that subjects to screen printing the substrate PB positioned by the substrate conveyance path 3. A direction of conveyance of the substrate PB in the screen printer 1 is taken as an X-axis direction, and a direction in a horizontal plane perpendicular to the X-axis direction is taken as a Y-axis direction. A vertical direction is taken as a Z-axis direction.

In FIGS. 2(a) and 2(b), the substrate PB is made by bonding an upper layer side substrate member 12 to an upper surface of a lower layer side substrate member 11. A plurality of flat portion electrodes 12d are provided on an upper surface of the upper layer side substrate member 12. Flat portion electrode patterns 12dp are formed on the upper surface of the upper layer side substrate member 12 from the plurality of flat portion electrodes 12d. A plurality of cavity portion electrodes 11d are provided in bottom surfaces (i.e., the upper surface of the lower layer side substrate member 11) of respective cavities CV that are apertures provided in portions of the upper surface of the upper layer side substrate member 12. The plurality of cavity portion electrodes 11d make up the cavity portion electrode patterns 11dp on bottom surfaces of the respective cavities CV. The substrate PB is a cavity substrate having the flat portion electrode patterns 12dp (first electrode patterns) formed on an upper surface (the upper surface of the upper layer side substrate member 12) and the cavity portion electrode patterns 11dp (second electrode patterns) formed in the bottom surfaces (the upper surface of the lower layer side substrate member 11) of the apertures (cavity portions CV) provided in portions of the upper surface.

In FIG. 1, the substrate conveyance path 3 includes carry-in conveyors 21, positioning conveyors 22, and carry-out conveyors 23 that are all aligned in the X-axis direction. The carry-in conveyors 21 convey the substrate PB charged into the screen printer 1 from the outside (a left side of a drawing sheet of FIG. 1) to an interior of the screen printer 1 and pass the substrate to the positioning conveyors 22. The positioning conveyors 22 positionally align the substrate PB received from the carry-in conveyors 21 to a predetermined location and pass the substrate PB to the carry-out conveyors 23 after the substrate PB has finished undergoing screen printing. The carry-out conveyors 23 convey the substrate PB, which has been received from the positioning conveyors 22, to the outside of the screen printer 1.

In FIG. 3, the print execution block 4 includes a substrate transfer unit 31 that clamps and moves the substrate PB held on the positioning conveyors 22 in a direction within a horizontal plane (in both the X-axis direction and the Y-axis direction) and the vertical direction (in the Z-axis direction); a pair of support rails 32 provided so as to extend over the substrate transfer unit 31 in a horizontal direction (i.e., the Y-axis direction); and a plate-shaped mask member 33 supported by the support rails 32. The print execution block 4 further includes a paste feed head 34 that is provided so as to move over the mask member 33 in a direction within the horizontal plane and that freely ascends or descends; a camera unit 36 that is provided so as to be movable, in a space between the substrate transfer unit 31 and the mask member 33, along a direction within the horizontal plane by means of a XY robot 35 (FIG. 1) provided on the base 2; and a cleaning unit 37 that is provided so as to be movable beneath the support rails 32 in both the vertical direction and in a direction within the horizontal plane and that comes into contact with a lower surface of the mask member 33 from below, to thus clean a residual paste on the lower surface of the mask member 33 after performance of screen printing operation.

In FIG. 3, the substrate transfer unit 31 of the print execution block 4 includes a Y table 31a that relatively moves in the Y-axis direction with respect to the base 2; an X table 31b that relatively moves in the X-axis direction with respect to the Y table 31a; a θ table 31c that relatively rotates around a Z axis with respect to the X table 31b; a base plate 31d fastened to the θ table 31c; a first elevation plate 31 e that relatively ascends or descends with respect to the base plate 31d; a second elevation plate 31f that relatively ascends or descends with respect to the first elevation plate 31e; a support unit 31g fastened to the second elevation plate 31f; and a pair of clampers 31h that perform opening and closing operations in the Y-axis direction above the positioning conveyors 22 making up the substrate conveyance path 3.

In FIG. 1 and FIGS. 4(a) and 4(b), four sides of the mask member 33 are supported by a frame member 33w which assumes a rectangular geometry when viewed from above. A cavity portion correspondence mask area MRC and a flat portion correspondence mask area MRF, which are mutually different areas, are provided within a rectangular area enclosed by the frame member 33w. A plurality of downwardly-projecting fitting portions 33a to be fitted into corresponding cavity portions CV of the substrate PB that are mutually different areas are formed in the cavity portion correspondence mask area MRC. A plurality of pattern holes h1 corresponding to the plurality of respective cavity portion electrodes lid provided on an upper surface of the lower layer side substrate member 11 (i.e., respective bottom surfaces of the cavity portions CV) are opened in the respective fitting portions 33a, whereby a cavity portion correspondence mask pattern MPC is formed. Moreover, a plurality of pattern holes h2 corresponding to the plurality of flat portion electrodes 12d provided on the upper surface of the upper layer side substrate member 12 are opened in the flat portion correspondence mask area MRF, whereby a flat portion correspondence mask pattern MPF is formed.

In short, the mask member 33 has the cavity portion correspondence mask area MRC and the flat portion correspondence mask area MRF that are mutually different areas. In the cavity portion correspondence mask area MRC, the cavity portion correspondence mask pattern MPC corresponding to the cavity portion electrode patterns 11dp is formed on respective bottom surfaces of the fitting portions 33a fitted into the respective cavity portions CV (the apertures of the upper layer side substrate member 12) of the substrate PB. The flat portion correspondence mask pattern MPF corresponding to the flat portion electrode patterns 12dp are formed in the flat portion correspondence mask area MRF. As is seen from FIG. 1, the flat portion correspondence mask area MRF is made up of one of two mask members 33 situated side by side with a center line CL of the mask member 33 parallel to a direction of conveyance of the substrate PB (the X-axis direction) interposed therebetween. The cavity portion correspondence mask area MRC is made up of the other of the two mask members 33 situated side by side with the center line CL of the mask member 33 parallel to the direction of conveyance of the substrate PB interposed therebetween.

In FIGS. 2(a) and 2(b), a pair of cavity portion side positioning marks 11m are provided at diagonal positions of the lower layer side substrate member 11. A pair of flat portion side positioning marks 12m are provided at diagonal positions of the upper layer side substrate member 12.

In the meantime, in FIG. 1 and FIG. 4(a), a pair of cavity portion correspondence mask area side positioning marks MKC for positionally aligning the cavity portion correspondence mask area MRC to the cavity portion electrode patterns 11dp of the substrate PB are provided at diagonal positions of the cavity portion correspondence mask area MRC where the cavity portion correspondence mask pattern MPC of the mask member 33 is formed, in correspondence with the cavity portion side positioning marks 11m. A pair of flat portion correspondence mask area side positioning marks MKF for positionally aligning the flat portion correspondence mask area MRF to the flat portion electrode patterns 12dp of the substrate PB are provided at diagonal positions of the flat portion correspondence mask area MRF where the flat portion correspondence mask pattern MPF of the mask member 33 is formed, in correspondence with the flat portion side positioning marks 12m.

In FIG. 3, the paste feed head 34 is provided so as to be movable above the support rails 32 in the Y-axis direction and with respect to the substrate transfer unit 31. The paste feed head 34 includes a head main body 34a and two guide members 34g that are provided in a lower portion of the head main body 34a and that oppose each other along the Y-axis direction. Each of the guide members 34g is a spatulate member extending in the X-axis direction and guides paste, such as solder paste and conductive paste, forcefully fed in a downward direction from a paste cartridge (not shown) built in the head main body 34a such that the paste is concentrically fed to a target position on the mask member 33.

In FIG. 1, the XY robot 35 includes a Y-axis stage 35a that extends in the Y-axis direction over the base 2 and that is fixedly provided so as to become relative to the base 2; an X-axis stage 35b that extends in the X-axis direction and that is provided so as to be movable above the Y-axis stage 35a in the Y-axis direction; and an actuation plate 35c that is provided so as to become movable over the X-axis stage 35b in the X-axis direction. In FIG. 3, the camera unit 36 is configured by attaching to the actuation plate 35c of the XY robot 35 a first camera 36a whose imaging plane is downwardly directed and a second camera 36b whose imaging plane is upwardly directed.

In FIG. 3, a cleaning unit 37 is brought into contact with a lower surface of the mask member 33 from below with horizontally stretched cleaning paper 37a, and the cleaning paper 37a is horizontally fed by means of a pair of rollers 37b, whereby the lower surface of the mask member 33 can be cleaned.

Operations for conveying and positioning the substrate PB performed by the carry-in conveyors 21, the positioning conveyors 22, and the carry-out conveyors 23 that make up the substrate conveyance path 3 are performed by means of a controller 40 (FIG. 5) of the screen printer 1 controlling operation of a substrate conveyance path actuation mechanism 41 (FIG. 5) made up of an unillustrated actuator.

Operations, such as moving the Y table 31a in the Y-axis direction with respect to the base 2, operation for moving the X table 31b in the X-axis direction with respect to the Y table 31a, operation for rotating a θ table 31c around the Z axis with respect to the X table 31b; operation for elevating or lowering the first elevation plate 31e with respect to the base plate 31d (i.e., the θ table 31c); operation for elevating or lowering the second elevation plate 31f (namely, the support unit 31g) with respect to the first elevation plate 31e, and operation for opening and closing the clampers 31h are performed by means of the controller 40 controlling operations of a substrate transfer unit actuation mechanism 42 (FIG. 5) made up of actuators, such as a Y table actuation motor My and an X table actuation motor Mx (FIG. 3).

Operation for moving the paste feed head 34 in the direction within a horizontal plane is performed by means of the controller 40 controlling operation of the paste feed head horizontal actuation mechanism 43 (FIG. 5) made up of an unillustrated actuator, or the like. Operation for elevating or lowering the the paste feed head 34 is performed by means of the controller 40 controlling operation of a paste feed head elevation mechanism 44 (FIG. 5) made up of an unillustrated actuator, or the like. Further, operation for feeding paste from the paste feed head 34 is performed by means of the controller 40 controlling operation of a paste feed mechanism 45 (FIG. 5) made up of an unillustrated actuator, or the like.

Operation for moving the X-axis stage 35b making up the XY robot 35 in the Y-axis direction and operation for moving the actuation plate 35c in the X-axis direction are performed by means of the controller 40 controlling operation of an XY robot actuation mechanism 46 (FIG. 5) made up of an unillustrated actuator, or the like.

Under control of the controller 40, the first camera 36a captures images of the cavity portion side positioning marks 11m provided on the lower layer side substrate member 11 of the substrate PB and images of the flat portion side positioning marks 12m provided on the upper layer side substrate member 12. Under control of the controller 40, the second camera 36b captures images of the cavity portion correspondence mask area side positioning marks MKC and the flat portion correspondence mask area side positioning marks MKF. Image data acquired by image capturing operation of the first camera 36a and image data acquired by image capturing operation of the second camera 36b are input to the controller 40 (FIG. 5).

Operation for moving the cleaning unit 37 in a direction within the horizontal plane is performed by means of the controller 40 controlling operation of a cleaning unit horizontal actuation mechanism 47 (FIG. 5) made up of an unillustrated actuator, or the like. Operation for elevating and lowering the cleaning unit 37 is performed by means of the controller 40 controlling operation of a cleaning unit elevation mechanism 48 made up of an unillustrated actuator, or the like. Further, cleaning operation of the cleaning unit 37 (operation for feeding the cleaning paper 37a performed by the pair of rollers 37b) is performed by means of the controller 40 controlling operation of a cleaning operation mechanism 49 (FIG. 5) made up of an unillustrated actuator, or the like.

During operation for subjecting the cavity portion electrode patterns 11dp to screen printing involving use of the mask members 33, the controller 40 first brings the substrate PB and the mask members 33 into relative proximity to each other in the vertical direction (as designated by an arrow A1 shown in FIG. 6(a)) while the cavity portion side positioning marks 11m provided on the lower layer side substrate member 11 of the substrate PB and the cavity portion correspondence mask area side positioning marks MKC provided on the cavity portion correspondence mask area MRC of the mask member 33 are made coincide with each other in the vertical direction (FIG. 6(a)). The controller 40 then makes the fitting portions 33a in the cavity portion correspondence mask area MRC of the mask member 33 fit to the corresponding cavity portions CV of the substrate PB from above (FIG. 6(b)). The cavity portion correspondence mask area MRC of the mask member 33 and the cavity portion electrode patterns 11dp of the substrate PB are thereby positioned. Next, the paste feed head 34 forcefully feeds the paste PT to the respective fitting portions 33a in the cavity portion correspondence mask area MRC from above. The paste PT is thereby fed to the respective cavity portion electrodes 11d making up the cavity portion electrode patterns 11dp by way of the respective pattern holes h1 making up the cavity portion correspondence mask pattern MPC (FIG. 6(c)). So long as the substrate PB and the mask member 33 are relatively separated apart from each other in the vertical direction (as designated by an arrow A2 shown in FIG. 6(d)), the paste PT is printed (transferred onto) on the respective cavity portion electrodes 11d (FIG. 6(d)).

In the meantime, during operation for subjecting the flat portion electrode patterns 12dp to screen printing involving use of the mask members 33, the controller 40 first brings the substrate PB and the mask members 33 into relative proximity to each other in the vertical direction (as designated by an arrow B1 shown in FIG. 7(a)) while the flat portion side positioning marks 12m provided on the upper layer side substrate member 12 of the substrate PB and the flat portion correspondence mask area side positioning marks MKF provided on the flat portion correspondence mask area MRF of the mask member 33 are made coincide with each other in the vertical direction (FIG. 7(a)). The controller 40 brings the substrate PB into contact with the mask members 33 (FIG. 7(b)). The flat portion correspondence mask area MRF of the mask member 33 and the flat portion electrode patterns 12dp of the substrate PB are positioned. Next, the paste feed head 34 forcefully feeds the paste PT to the flat portion correspondence mask area MRF from above. The paste PT is thereby fed to the respective flat portion electrodes 12d making up the flat portion electrode patterns 12dp by way of the respective pattern holes h2 making up the flat portion correspondence mask pattern MPF (FIG. 7(c)). So long as the substrate PB and the mask member 33 are relatively separated apart from each other in the vertical direction (as designated by an arrow B2 shown in FIG. 7(d)), the paste PT is printed on the respective flat portion electrode electrodes 12d (FIG. 7(d)).

Since the flat portion correspondence mask area MRF of the mask member 33 assumes a planar shape, the paste PT on the cavity portion electrodes 11d do not interfere with the mask member 33 even when the flat portion correspondence mask area MRF of the mask member 33 is brought into contact with the upper surface of the substrate PB while the paste PT remains printed on the respective cavity portion electrodes 11d. For this reason, it is possible to print the paste PT to the flat portion electrode patterns 12dp by use of the flat portion correspondence mask area MRF of the mask member 33 while the paste PT remains printed on the respective cavity portion electrodes 11d (see FIG. 7). Consequently, so long as printing the paste PT to the cavity portion electrode patterns 11dp before performance of printing the paste PT to the flat portion electrode patterns 12dp is performed, it is possible to perform both printing the paste PT to the cavity portion electrode patterns 11dp and printing the paste PT to the flat portion electrode patterns 12dp.

Procedures along which the screen printer 1 performs screen printing are now described by use of a flowchart of FIG. 8 and descriptive operation views of FIG. 9 through 12. When detected that an operator (or an unillustrated another apparatus installed at an upstream position with respect to the screen printer 1) has charged the substrate PB into the substrate conveyance path 3 by unillustrated detection means, the controller 40 synchronously activates the carry-in conveyors 21 and the positioning conveyors 22, thereby conveying the substrate PB into the screen printer 1 (in step ST1 shown in FIG. 8).

When conveyed the substrate PB into the printer, the controller 40 fixes the substrate PB to the substrate transfer unit 31 (in step ST2 shown in FIG. 8). First, the second elevation plate 31f of the substrate transfer unit 31 is relatively elevated with respect to the first elevation plate 31e (as designated by an arrow C1 shown in FIG. 9(a)), and an upper surface of the support unit 31g is brought into contact with the lower surface of the substrate PB, thereby letting the support unit 31g support the substrate PB (FIG. 9(a)). After the support unit 31g has supported the substrate PB, the clampers 31h clamp the substrate PB, and the second elevation plate 31f is further elevated (as designated by an arrow C2 shown in FIG. 9(b)). The support unit 31g thereby pushes up the substrate PB. The substrate PB then ascends while its both ends are making slidable movement with respect to the dampers 31h, to thus depart from the positioning conveyors 22 in the upward direction. The substrate PB is then fixed to the substrate transfer unit 31 while the upper surface of the substrate PB remains in level with the upper surfaces of both clampers 31h (FIG. 9(b)).

After having completed fixing of the substrate PB, the controller 40 positionally aligns the cavity portion correspondence mask area MRC of the mask member 33 to the cavity portion electrode patterns 11dp of the substrate PB (in step ST3 shown in FIG. 8).

During positioning operation, the controller 40 first controls movement of the camera unit 36 and image capturing operation of the first camera 36a, thereby acquiring image data pertaining to the cavity portion side positioning marks 11m provided on the lower layer side substrate member 11 and ascertaining positions of the cavity portion electrode patterns 11dp. Further, the controller 40 controls movement of the camera unit 36 and image capturing operation of the second camera 36b, thereby acquiring image data pertaining to the cavity portion correspondence mask area side positioning mark MKC provided on the mask member 33 and ascertaining position of the cavity portion correspondence mask area MRC.

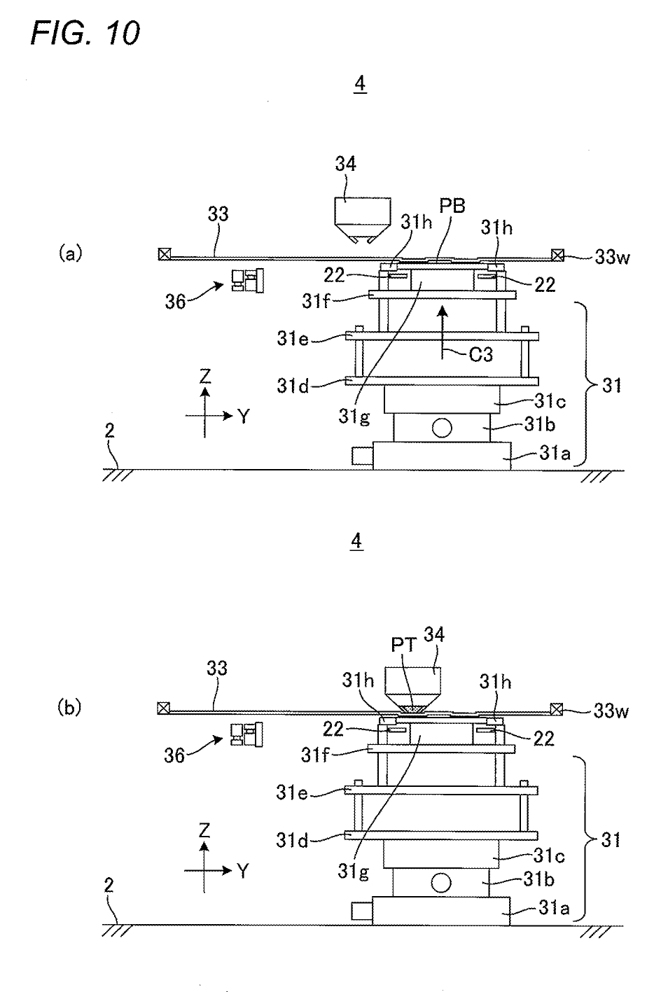

After having ascertained the positions of the cavity portion electrode patterns 11dp and the position of the cavity portion correspondence mask area MRC, the controller 40 performs operation for letting the substrate transfer unit 31 move the substrate PB in a direction within the horizontal plane, thereby placing the substrate PB at a position immediately below the cavity portion correspondence mask area MRC of the mask member 33. Further, the substrate transfer unit 31 is made perform operation for moving the substrate PB in the vertical direction (i.e., elevation of the first elevation plate 31e), thereby bringing the substrate PB into contact with the mask member 33 from below (as designated by an arrow C3 shown in FIG. 10(a)). The cavity portion correspondence mask area MRC of the mask member 33 and the cavity portion electrode patterns 11dp of the substrate PB are positionally aligned to each other (FIG. 10(a)).

After having finished positionally aligning the cavity portion correspondence mask area MRC of the mask member 33 to the cavity portion electrode patterns 11dp of the substrate PB, the controller 40 performs subjecting the cavity portion electrode patterns 11dp to screen printing (in step ST4 shown in FIG. 8).

During operation for subjecting the cavity portion electrode patterns 11dp to screen printing, the controller 40 first moves the paste feed head 34 to a position above the cavity portion correspondence mask area MRC and feeds the paste PT over the upper surface of the mask member 33 (an interior of the cavity portion correspondence mask area MRC) from the paste feed head 34 by way of a space between the guide members 34g, thereby filling the pattern holes h1 of the cavity portion correspondence mask pattern MPC with the paste PT (FIG. 10(b)).

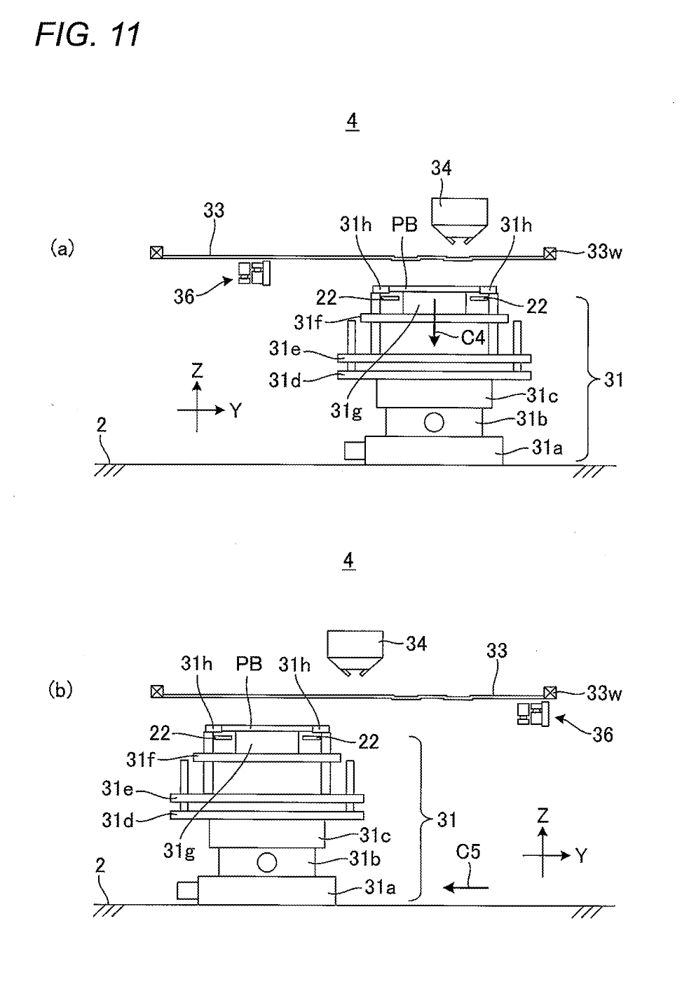

After having filled the patterns h1 of the cavity portion correspondence mask pattern MPC with the paste PT, the controller 40 lowers the first elevation plate 31e (as designated by an arrow C4 shown in FIG. 11(a)). The substrate PB and the mask member 33 are separated from each other (in step ST5 shown in FIG. 8). Separation of the substrate and the mask member is thereby performed, whereupon the paste PT filled in the respective pattern holes h1 of the cavity portion correspondence mask pattern MPC is printed on the cavity portion electrode patterns 11dp (FIG. 11(a)).

Processing pertaining to a screen printing process for the cavity portion electrode patterns 11dp (a first screen printing process; steps ST3 to ST5) is thereby completed. Processing pertaining to a screen printing process for the flat portion electrode patterns 12dp (a second screen printing process; steps ST6 to ST9) is then performed.

During the screen printing process for the flat portion electrode patterns 12dp, the controller 40 first positionally aligns the flat portion correspondence mask area MRF of the mask member 33 to the flat portion electrode patterns 12dp of the substrate PB (in step ST6 shown in FIG. 8).

During positioning operation, the controller 40 first controls movement of the camera unit 36 and image capturing operation of the first camera 36a, thereby acquiring image data pertaining to the flat portion side positioning marks 12m provided on the upper layer side substrate member 12 and ascertaining positions of the flat portion electrode patterns 12dp. Further, the controller 40 controls movement of the camera unit 36 and image capturing operation of the second camera 36b, thereby acquiring image data pertaining to the flat portion correspondence mask area side positioning mark MKF provided on the mask member 33 and ascertaining position of the flat portion correspondence mask area MRF.

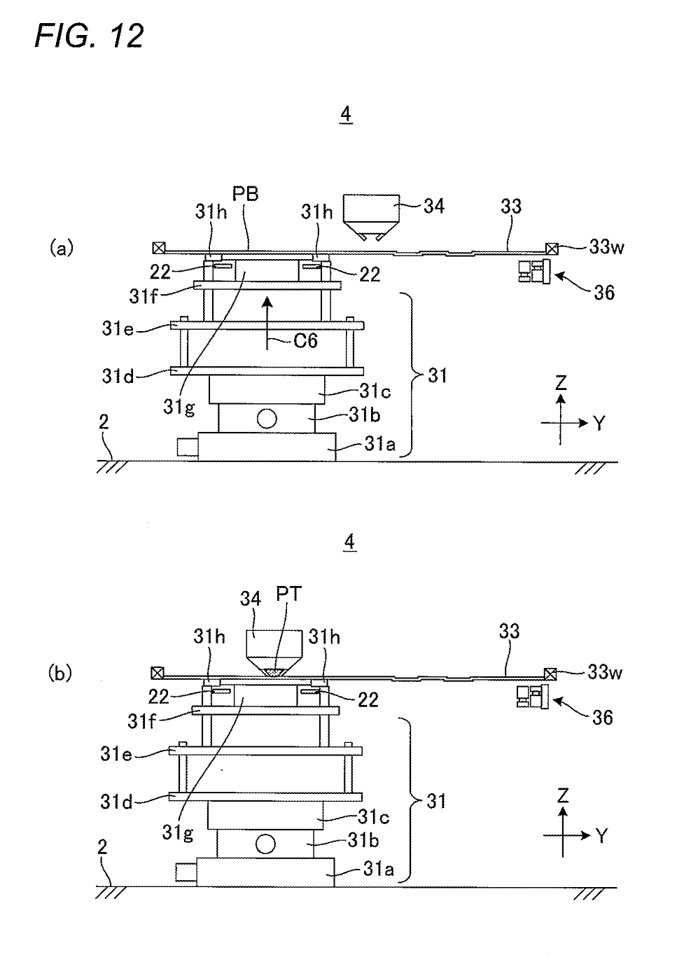

After having ascertained the positions of the flat portion electrode patterns 12dp and the position of the flat portion correspondence mask area MRF, the controller 40 performs operation for letting the substrate transfer unit 31 move the substrate PB in a direction within the horizontal plane (as designated by an arrow C5 shown in FIG. 11(b)), thereby placing the substrate PB at a position immediately below the flat portion correspondence mask area MRF of the mask member 33 (FIG. 11(b)). Further, the substrate transfer unit 31 is made perform operation for moving the substrate PB in the vertical direction (i.e., elevation of the first elevation plate 31e), thereby bringing the substrate PB into contact with the lower surface of the mask member 33 from below (as designated by an arrow C6 shown in FIG. 12(a)). The flat portion correspondence mask area MRF of the mask member 33 and the flat portion electrode patterns 12dp of the substrate PB are positionally aligned to each other (FIG. 12(a)).

As mentioned above, the screen printer 1 of the present embodiment is configured so as to positionally align the flat portion correspondence mask area MRF to the flat portion electrode patterns 12dp by use of the first marks (i.e., the flat portion correspondence mask area side positioning marks MKF and the flat portion side positioning marks 12m) that are provided on the upper surface of the flat portion correspondence mask area MRF of the mask member 33 and the upper surface of the upper layer side substrate member 12 in order to positionally align the flat portion correspondence mask area MRF of the mask member 33 to the flat portion electrode patterns 12dp of the substrate PB. Further, the screen printer 1 of the present embodiment is also configured so as to positionally align the cavity portion correspondence mask area MRC to the cavity portion electrode patterns 11dp by use of the second marks (i.e., the cavity portion correspondence mask area side positioning marks MKC and the cavity portion side positioning marks 11m) that are provided on the upper surface of the cavity portion correspondence mask area MRC of the mask member 33 and the upper surface of the lower layer side substrate member 11, which corresponds to bottom surfaces of the apertures (the cavity portions CV) of the upper layer side substrate member 12, in order to positionally align the cavity portion correspondence mask area MRC of the mask member 33 to the cavity portion electrode patterns 1dp of the substrate PB.

In short, different marks are used for aligning the flat portion correspondence mask area MRF to the flat portion electrode patterns 12dp and aligning the cavity portion correspondence mask area MRC to the cavity portion electrode patterns 11dp.

After having finished positionally aligning the flat portion correspondence mask area MRF of the mask member 33 to the flat portion electrode patterns 12dp of the substrate PB, the controller 40 performs subjecting the flat portion electrode patterns 12dp to screen printing (in step ST7 shown in FIG. 8).

During operation for subjecting to the flat portion electrode patterns 12dp to screen printing, the controller 40 first moves the paste feed head 34 to a position above the flat portion correspondence mask area MRF and feeds the paste PT over the upper surface of the mask member 33 (an interior of the flat portion correspondence mask area MRF) from the paste feed head 34 by way of the space between the guide members 34g, thereby filling the pattern holes h2 of the flat portion correspondence mask pattern MPF with the paste PT (FIG. 12(b)).

After having filled the pattern holes h2 of the flat portion correspondence mask pattern MPF with the paste PT, the controller 40 lowers the first elevation plate 31e, thereby separating the substrate PB and the mask member 33 apart from each other (in step ST8 shown in FIG. 8). Separation of the substrate and the mask member is thereby performed, whereupon the paste PT filled in the respective pattern holes h2 in the flat portion correspondence mask pattern MPF is printed on the flat portion electrode patterns 12dp. Processing pertaining to the second screen printing process for the flat portion electrode patterns 12dp is thereby completed.

After processing pertaining to a screen printing process for the flat portion electrode patterns 12dp has been completed, the controller 40 lets the clampers 31h open, thereby releasing the substrate PB from the secured state provided by the substrate transfer unit 31 (in step ST9 in FIG. 8). The second elevation plate 31f is lowered, to thus place the substrate PB onto the positioning conveyors 22. The substrate transfer unit 31 is then activated, thereby adjusting the position of the positioning conveyors 22 with respect to the carry-out conveyors 23. After having finished adjusting the position of the positioning conveyors 22 with respect to the carry-out conveyors 23, the controller 40 synchronously activates the positioning conveyors 22 and the carry-out conveyors 23, thereby conveying the substrate PB out of the screen printer 1 (in step ST10 shown in FIG. 8).

After the substrate PB has been conveyed out, the controller 40 determines whether or not there is another substrate PB to be subjected to screen printing (in ST11 shown in FIG. 8). As a result, when there is another substrate PB to be subjected to screen printing, processing returns to step ST1, and the substrate PB is conveyed into the screen printer. On the contrary, when there is no substrate PB to be subjected to screen printing, processing pertaining to a series of screen printing processes is completed.

If the controller 40 has first subjected the flat portion electrode patterns 12dp to screen printing, a problem of the paste PT previously printed to the flat portion electrode patterns 12dp adhering to the lower surface of the mask member 33 will arise in operation to be performed later during which the mask member 33 (the cavity portion correspondence mask area MRC) for the cavity portion electrode patterns 11dp is brought into contact with the substrate PB. On the contrary, in the screen printer 1 of the present embodiment, the controller 40 positionally aligns the cavity portion correspondence mask area MRC of the mask member 33 to the cavity portion electrode patterns 11dp of the substrate PB and subsequently performs processing pertaining to a process for subjecting the cavity portion electrode patterns 11dp to screen printing (a first screen printing process). The controller then positionally aligns the flat portion correspondence mask area MRF of the mask member 33 to the flat portion electrode patterns 12dp of the substrate PB and subsequently performs processing pertaining to a process (a second screen printing process) for subjecting the flat portion electrode patterns 12dp to screen printing. Therefore, occurrence of a problem, such as that mentioned above, can be prevented.

After the controller 40 has completed processing pertaining to a series of screen printing processes, the cleaning unit 37 cleans the lower surface of the mask member 33. During cleaning of the lower surface of the mask member 33, cleaning the cavity portion correspondence mask area MRC and cleaning the flat portion correspondence mask area MRF are performed separately from each other.

As shown in FIG. 13(a), the cavity portion correspondence mask area MRC of the mask member 33 is cleaned by means of bringing the cleaning paper 37a of the cleaning unit 37 into contact with lower surfaces of the bottom surfaces of the fitting portions 33a in the cavity portion correspondence mask area MRC, feeding the cleaning paper 37a by use of the pair of rollers 37b while the cleaning unit 37 is being moved along any direction within the horizontal plane (as designated by an arrow D1 shown in FIG. 13(a)), and removing residual paste PT adhering to the lower surface of the cavity portion correspondence mask area MRC (a first cleaning process). Further, as shown in FIG. 13(b), the flat portion correspondence mask area MRF of the mask member 33 is cleaned by means of bringing the cleaning paper 37a of the cleaning unit 37 into contact with lower surface of the flat portion correspondence mask area MRF, feeding the cleaning paper 37a by use of the pair of rollers 37b while the cleaning unit 37 is being moved along any direction within the horizontal plane (as designated by an arrow D2 shown in FIG. 13(b)), and removing residual paste PT adhering to the lower surface of the flat portion correspondence mask area MRF (a second cleaning process).

As described above, the screen printer 1 of the present embodiment is for subjecting to screen printing the flat portion electrode patterns 12dp (first electrode patterns) formed on the upper surface of the substrate PB and the cavity portion electrode patterns 11dp (second electrode patterns) formed on the respective bottom surfaces of the cavity portions CV that are apertures formed in portions of the upper surface of the substrate PB. The screen printer has the mask member 33 and the cleaning unit 37. The mask member 33 includes, as separate areas, the cavity portion correspondence mask area MRC (a second electrode pattern correspondence mask area) in which the cavity portion correspondence mask pattern MPC (a second electrode pattern correspondence mask pattern) corresponding to the cavity portion electrode patterns 11dp are formed on the bottom surfaces of the fitting portions 33a to be fitted into the cavity portions CV and the flat portion correspondence mask area MRF (a first electrode pattern correspondence mask area) in which the flat portion correspondence mask pattern MPF (a first electrode pattern correspondence mask pattern) corresponding to the flat portion electrode patterns 12dp is formed. The cleaning unit 37 comes into contact with the lower surfaces (the bottom surfaces) of the fitting portions 33a within the cavity portion correspondence mask area MRC of the mask member 33, to thus clean the cavity portion correspondence mask area MRC. The cleaning unit 37 also comes into contact with the lower surface of the flat portion correspondence mask area MRF of the mask member 33, to thus clean the flat portion correspondence mask area MRF.

A method for cleaning the screen printer 1 of the present embodiment is a cleaning method for the screen printer 1 that subjects, to screen printing by use of the mask member 33, the flat portion electrode patterns 12dp (the first electrode patterns) formed on the upper surface of the substrate PB and the cavity portion electrode patterns 11dp (the second electrode patterns) formed on the respective bottom surfaces of the cavity portions CV that are apertures provided in portions of the supper surface of the substrate PB. The mask member 33 includes, as separate areas, the cavity portion correspondence mask area MRC (the second electrode pattern correspondence mask area) in which the cavity portion correspondence mask pattern MPC (the second electrode pattern correspondence mask pattern) corresponding to the cavity portion electrode patterns 11dp are formed on the bottom surfaces of the fitting portions 33a to be fitted into the cavity portions CV and the flat portion correspondence mask area MRF (the first electrode pattern correspondence mask area) in which the flat portion correspondence mask pattern MPF (the first electrode pattern correspondence mask pattern) corresponding to the flat portion electrode patterns 12dp is formed. The cleaning method includes a step of (a first cleaning step) of brining the cleaning unit 37 into contact with the lower surfaces (the bottom surfaces) of the respective fitting portions 33a in the cavity portion correspondence mask area MRC of the mask member 33, to thus clean the cavity portion correspondence mask area MRC and a cleaning step (a second cleaning step) of bringing the cleaning unit 37 into contact with the lower surface of the flat portion correspondence mask area MRF of the mask member 33, to thus clean the flat portion correspondence mask area MRF.

In the screen printer 1 and the method for cleaning the screen printer 1 of the embodiment, the mask member 33 includes, as separate areas, the cavity portion correspondence mask area MRC in which the cavity portion correspondence mask pattern MPC corresponding to the cavity portion electrode patterns 11dp are formed on the bottom surfaces of the fitting portions 33a to be fitted into the apertures of the substrate PB (the cavity portions CV) and the flat portion correspondence mask area MRF in which the flat portion correspondence mask pattern MPF corresponding to the flat portion electrode patterns 12dp is formed. Cleaning the flat portion correspondence mask area MRF of the mask member 33 and cleaning the cavity portion correspondence mask area MRC are performed separately from each other. Accordingly, it is possible to clean the flat portion correspondence mask area MRF without being interrupted by the fitting portions 33a in the cavity portion correspondence mask area MRC, so that the three dimensional mask member 33 intended for the cavity substrate can properly be cleaned.

Although the embodiment of the present invention has been described thus far, the present invention is not limited to the foregoing embodiment. For instance, the present embodiment has illustrated the case where the substrate PB is a cavity substrate made by bonding two substrate members (the lower layer side substrate member 11 and the upper layer side substrate member 12) together. However, the substrate PB that is the target of the present invention is not limited to any particular structure, and the essential requirement for the substrate PB is that the substrate shall have the cavity portion electrode patterns 11dp formed on the respective bottom surfaces of the cavity portions CV that are provided as the apertures on the upper surface of the substrate PB and the flat portion electrode patterns 12dp formed on the upper surface of the substrate. A paste feeding scheme may also be a scheme for feeding paste by means of an open squeegee and is not limited to the paste cartridge.

The present patent application is based on Japanese Patent Application (JP-2009-062316) filed on Mar. 16, 2009, the entire subject matter of which is incorporated herein by reference.

### INDUSTRIAL APPLICABILITY

There is provided a screen printer capable of properly cleaning a three dimensional mask member intended for a cavity substrate and a method for cleaning the screen printer.

### DESCRIPTIONS OF THE REFERENCE NUMERALS AND SYMBOLS

1 Screen Printer
11dp Cavity Portion Electrode Patterns (Second Electrode Patterns)
12dp Flat Portion Electrode Patterns (First Electrode Patterns)
33 Mask Member
33a Fitting Portions
37 Cleaning Unit
MPC Cavity Portion Correspondence Mask Pattern (Second Electrode Pattern Correspondence Mask Pattern)
MPF Flat Portion Correspondence Mask Pattern (First Electrode Pattern Correspondence Mask Pattern)
MRC Cavity Portion Correspondence Mask Area (Second Electrode Pattern Correspondence Mask Area)
MRF Flat Portion Correspondence Mask Area (First Electrode Pattern Correspondence Mask Area)
PB Substrate
CV Cavity Portion (Aperture)
CL Center Line Of Mask Member

1. A screen printer that subjects first electrode patterns formed on an upper surface of a substrate and second electrode patterns formed on bottom surfaces of apertures provided on portions of the upper surface of the substrate to screen printing, the printer comprising:
a mask member having, respectively as different areas, a second electrode pattern correspondence mask area in which a second electrode pattern correspondence mask pattern corresponding to the second electrode patterns is formed on bottom surfaces of fitting portion to be fitted to the apertures of the substrate and a first electrode pattern correspondence mask area in which a first electrode pattern correspondence mask pattern corresponding to the first electrode patterns is formed; and
a cleaning unit that contacts lower surfaces of the respective fitting portions in the second electrode pattern correspondence mask area of the mask member, to thus cleaning the second electrode pattern correspondence mask area and that contacts a lower surface of the first electrode pattern correspondence mask area of the mask member, to thus clean the first electrode pattern correspondence mask area.

2. The screen printer according to claim 1, wherein the first electrode pattern correspondence mask area is made up of one of two areas of the mask member that are situated side by side with a center line of the mask member parallel to a direction of conveyance of the substrate with interposed therebetween; and
the second electrode pattern correspondence mask area is made up of a remaining one of the two areas of the mask member that are situated side by side with the center line of the mask member parallel to a direction of conveyance of the substrate interposed therebetween.

3. A method for cleaning a screen printer that subjects to screen printing first electrode patterns formed on an upper surface of a substrate and second electrode patterns formed on bottom surfaces of apertures provided on portions of the upper surface of the substrate, by use of a mask member having, respectively as different areas, a second electrode pattern correspondence mask area in which a second electrode pattern correspondence mask pattern corresponding to the second electrode patterns is formed on bottom surfaces of fitting portion to be fitted to the apertures of the substrate and a first electrode pattern correspondence mask area in which a first electrode pattern correspondence mask pattern corresponding to the first electrode patterns is formed, the cleaning method comprising:
a step of brining the cleaning unit into contact with lower surfaces of the respective fitting portions in the second electrode pattern correspondence mask area of the mask member, to thus clean the second electrode pattern correspondence mask area; and
a step of bringing the cleaning unit into contact with the lower surface of the first electrode pattern correspondence mask area of the mask member, to thus clean the first electrode pattern correspondence mask area.

4. The method for cleaning a screen printer according to claim 3, wherein the first electrode pattern correspondence mask area is made up of one of two areas of the mask member that are situated side by side with a center line of the mask member parallel to a direction of conveyance of the substrate interposed therebetween; and
the second electrode pattern correspondence mask area is made up of a remaining one of the two areas of the mask member that are situated side by side with the center line of the mask member parallel to a direction of conveyance of the substrate interposed therebetween.
